(19) United States
(12) Patent Application Publication
(10) Pub. No.: US 2026/0159705 A1
(43) Pub. Date: Jun. 11, 2026

(54) IN-SITU POLYMERIZABLE, ELASTIC, RIGID, AND FATIGUE-RESISTANT COMPOSITE SOLID ELECTROLYTE FOR ALL-SOLID-STATE LITHIUM METAL BATTERIES

(71) Applicants: Samsung SDI Co., Ltd., Yongin-si (KR); Georgia Tech Research Corporation, Atlanta, GA (US)

(72) Inventors: Seung Woo Lee, Atlanta, GA (US); Minsu Kim, Atlanta, GA (US); Kyungmo Kim, Atlanta, GA (US); Hyewon Kang, Atlanta, GA (US); Hoyoung Lee, Cambridge, MA (US); Haemin Paik, Cambridge, MA (US)

(21) Appl. No.: 19/340,468

(22) Filed: Sep. 25, 2025

Related U.S. Application Data
(60) Provisional application No. 63/730,654, filed on Dec. 11, 2024.

(51) Int. Cl. C09D 5/24; C08F 220/18; C09D 4/00; C09D 133/08; H01M 10/052; H01M 10/056

(52) U.S. Cl. CPC C09D 5/24; C08F 220/1802; C09D 4/00; C09D 133/08; H01M 10/052; H01M 10/056; C08F 2810/20; H01M 2300/0082

(57) ABSTRACT

A polymerizable polymer composition, an entangled polymer including the polymerized composition, a composite solid electrolyte including the entangled polymer, an all-solid-state lithium metal battery including the composite solid electrolyte, and a method of preparing the polymerizable polymer composition are provided. The polymer composition includes first and second monomers, an unsaturated hydrocarbon, nanoparticles, a metal salt, and a stabilizer. The first and second monomers have first and second moieties, respectively, the unsaturated hydrocarbon has a third moiety, the surface of the nanoparticles has a coating having fourth moieties. The entangled polymer further includes ion transport pathways and chemical bonds between any of the first, second, third, and fourth moieties.

### CROSS-REFERENCE TO RELATED APPLICATIONS

This application claims priority to and the benefit of U.S. Provisional Application No. 63/730,654, filed on Dec. 11, 2024, in the United States Patent and Trademark Office, the entire content of which is incorporated herein by reference.

### BACKGROUND

### 1. Field

One or more embodiments of the present disclosure relate to a nickel-rich cathode active material having a protective coating, and a method of preparing the nickel-rich cathode active material. One or more embodiments relate to a rechargeable lithium battery including the nickel-rich cathode active material and a method of operating the rechargeable lithium battery.

### 2. Description of the Related Art

The rising global demand for energy storage systems (ESSs) in electric vehicles (EVs), renewable energy grids, and electronic devices such as smart phones, laptops, and/or the like, has created an urgent desire for advanced battery technologies. Traditional Li-ion batteries (LIBs) are approaching their theoretical energy density limits due to the restricted capacity of graphite anodes, which is about 372 milliampere hour per gram (mAh·g⁻¹)). As a result, LIBs may soon fail to provide the high capacity and high energy density requirements of high-performance applications.

Li metal batteries (LMBs) have garnered attention as a promising alternative, with the potential to deliver higher energy densities. Li metal, with a theoretical capacity of 3,860 mAh·g⁻¹, offers energy density improvements of 35% by weight and 50% by volume over LIBs. This enhanced energy density makes LMBs especially attractive for EV applications, where it translates to lighter battery packs and extended driving range. However, commercialization of LMBs is limited by Li dendrite formation, which can lead to short circuits, thermal runaway, and battery failure. Conventional liquid electrolytes in LMBs increase these risks, as they are susceptible to leakage and flammability.

To address these concerns, research has turned towards all-solid-state lithium (Li) metal batteries (ASSLMBs) which use solid state electrolytes (SSEs) and/or solid polymer electrolytes (SPEs). SSEs include oxide-based and sulfide-based ceramic electrolytes (CEs) that exhibit high ionic conductivity and mechanical rigidity. These SSEs can mitigate leakage and suppress dendrite growth to provide safe, high-energy-density LMBs, but they have poor interfacial contact, which increases interfacial resistance. In contrast, SPEs accommodate volume changes of electrodes to provide better interfacial compatibility, eliminate leakage and fire risks, and hold potential for Li dendrite suppression. However, the lower ionic conductivity and mechanical strength of SPEs, especially at room temperature, remain barriers to practical application. While SSEs offer significant safety improvements, they introduce challenges such as poor interfacial contact, insufficient room-temperature ionic conductivity, high manufacturing costs, and scalability issues. These factors limit battery performance and energy density, hindering commercialization.

Accordingly, there is a desire to integrate the rigidity and conductivity of SSEs (e.g., ceramics) with the flexibility and interfacial compatibility of SPEs (e.g., polymers) to provide a composite solid electrolyte having enhanced performance and stability suitable for use in ASSLMBs, e.g., in the high capacity and high energy density requirements of high-performance applications.

### SUMMARY

The present disclosure is directed toward a composite solid electrolyte (CSE) having favorable properties engineered for use in an all-solid-state lithium (Li) metal battery (ASSLMB). The favorable properties of the CSE include mechanical strength and rigidity sufficient to prevent dendrite formation and elasticity sufficient to accommodate volume changes of the anode and cathode during repeated cycling. The CSE of the present disclosure provides a conformal and stable electrode-electrolyte interface without the need for external pressure and the high energy density and enhanced safety needed for reliable operation of a rechargeable ASSLMB.

The mechanical strength and rigidity of the CSE are provided by a highly entangled polymer network including clusters of functionalized silica nanoparticles. Crosslinking of polymer chains throughout the entangled polymer network provides high elasticity to effectively distribute stress and prevent damage during repeated electrode expansion and contraction. The functionalized silica nanoparticles form covalent bonds to the polymer network to provide a rigid CSE having high fatigue resistance and ionic conductivity. Aggregation of the functionalized silica nanoparticles into clusters provides additional adhesion and mechanical strength and rigidity to the polymer network, further enabling the CSE to dissipate mechanical stress induced by electrode expansion and contraction.

The rigid structure of the CSE suppresses or prevents the formation of Li dendrites. The multiscale stress distribution of the CSE reduces or prevents the formation of cracks and maintains structural integrity under repeated strain, which further prevents the formation of Li dendrites.

The ionic conductivity of the CSE is provided by the functionalized silica nanoparticles and an imide salt-ionic complex that includes polar π bonds, which together facilitate formation of ion transport pathways.

The CSE of the present disclosure is prepared by in-situ polymerization of a polymer composition having a specific combination of components that provide the CSE with the favorable properties required for a high-performance ASSLMB. The present disclosure includes preparation of the polymer composition the in-situ polymerization to provide the CSE.

According to one or more embodiments of the present disclosure, a polymer composition includes: repeating units including a first monomer having a first moiety and a second monomer having at least one second moiety; an unsaturated hydrocarbon having at least one third moiety; nanoparticles having a coating on a surface thereof, the coating having fourth moieties; a metal salt; and a stabilizer, wherein the polymer composition is a polymerizable composition.

In one or more embodiments, the first monomer may include a (meth)acrylate, the second monomer may include a diacrylate, the unsaturated hydrocarbon may include a substituted or unsubstituted C₁ to C₁₈ N-containing unsaturated hydrocarbon, and the third moiety may include a cyano group, the metal salt may include at least one metal ion and at least one counter ion including —F, —Cl, —Br, —I, —OH, —S(═O)—, —S(═O)₂—, —C(═O)—, —C(═O)O—, —OC(═O), —OC(═O)O—, —CF₃, —CF₂H, —CFH₂, —CCl₃, or a combination thereof, and the stabilizer may include a carbonate, an ester, an ether, a ketone, an alcohol, or combinations thereof, each independently substituted or unsubstituted.

In one or more embodiments, each of the first moiety, the second moiety, the third moiety, and the fourth moieties, may independently be a double bond having at least one C atom or a triple bond having at least one C atom.

In one or more embodiments, the nanoparticles may have a core including a compound that may be a metal, a nonmetal, a metalloid, or a combination thereof.

In one or more embodiments, the nanoparticles may have a core including SiO₂.

In one or more embodiments, the coating may include a trialkoxysilyl alkyl acrylate.

In one or more embodiments, the nanoparticles may include: a single particle form including primary cores having the coating on a surface thereof, or a secondary particle form including secondary particles, each secondary particle including an aggregate of at least two primary cores.

In one or more embodiments, an average particle diameter of the primary cores may be about 100 nanometers (nm) to about 140 nm, and an average particle diameter of the secondary particles may be about 0.5 micrometers (μm) to about 50 μm.

In one or more embodiments, a ratio (RM) of moles of the second monomer to moles of the first monomer may be about 10⁻⁵ to about 10⁻².

In one or more embodiments, a ratio (RV) of a volume of the first monomer to a volume of the nanoparticles may be about 1:0 to about 1:1.

According to one or more embodiments of the present disclosure, an entangled polymer includes: a polymerized form of a polymer composition of the present disclosure; a plurality of chemical bonds between any selected from among the first moiety, the second moiety, the third moiety, and the fourth moieties; and ion transport pathways, the chemical bonds may include covalent bonds, ionic bonds, intermolecular attractions, and combinations thereof.

In one or more embodiments, the entangled polymer may include an ionic complex that includes the unsaturated hydrocarbon and the metal salt.

In one or more embodiments, the entangled polymer may have a rubbery plateau modulus.

In one or more embodiments, the entangled polymer may have an elastic modulus of about 100 megapascal (MPa) to about 1,000 MPa.

In one or more embodiments, a stretchability of the entangled polymer may be about 500% to about 3,000%.

According to one or more embodiments, a composite solid electrolyte includes the entangled polymer of the present disclosure.

In one or more embodiments the composite solid electrolyte may have an ionic conductivity of about 3 millisiemens per centimeter (mS/cm) to about 4 mS/cm.

According to one or more embodiments of the present disclosure, an all-solid-state lithium metal battery includes: a cathode; an anode; and a composite solid electrolyte of the present disclosure.

According to one or more embodiments of the present disclosure, a method of preparing a polymerizable composition for a composite solid electrolyte includes: providing a polymer composition including a metal salt, a stabilizer, a thermal initiator, a first monomer having a first moiety, a second monomer having at least one second moiety, an unsaturated hydrocarbon having at least one third moiety, and nanoparticles having a coating on a surface thereof, the coating having fourth moieties; and mixing the composition to provide a polymerizable composition.

In one or more embodiments, the method is a method of preparing an entangled polymer for a composite solid electrolyte for an all-solid-state lithium metal battery and may include: heat treating the polymerizable composition to provide an entangled polymer, the entangled polymer having a plurality of chemical bonds between any selected from among the first moiety, the second moiety, the third moiety, and the fourth moieties, and ion transport pathways.

Additional aspects of embodiments will be set forth in part in the description which follows and, in part, will be apparent from the description, or may be learned by practice of the presented embodiments of the disclosure.

### BRIEF DESCRIPTION OF THE DRAWINGS

The preceding and other objects and features of embodiments of the present disclosure will become more apparent to those of ordinary skill in the art by describing example embodiments thereof in more detail with reference to the accompanying drawings. In the drawings:

FIG. 1 is a schematic drawing of a composite solid electrolyte according to one or more embodiments;

FIG. 2 is a chart of stiffness measurements of composite solid electrolytes according to one or more embodiments;

FIG. 3 is a chart of ionic conductivity measurements of composite solid electrolytes according to one or more embodiments;

FIG. 4 is a chart of nanoindentation of elastic modulus for composite solid electrolytes according to one or more embodiments;

FIG. 5A shows scanning electron microscopy (SEM) images of composite solid electrolytes according to one or more embodiments;

FIG. 5B is a set of images showing the stretchability analysis of a composite solid electrolyte according to one or more embodiments;

FIG. 5C is a chart of indentation resistance of a composite solid electrolyte according to one or more embodiments;

FIG. 6 is a chart of electrochemical performance of composite solid electrolytes according to one or more embodiments;

FIGS. 7A-7B are charts of electrochemical stability of composite solid electrolytes according to one or more embodiments;

FIG. 8A is a chart of charge transfer resistance of an electrochemical cell including a composite solid electrolyte according to one or more embodiments;

FIG. 8B is an SEM image of the electrochemical cell described in FIG. 8A;

FIG. 8C is a chart of plating and stripping analysis of the electrochemical cell described in FIG. 8A;

FIGS. 9A-9B are charts of the electrochemical performance of electrochemical cells including a composite solid electrolyte according to one or more embodiments;

FIG. 10 is a chart of the electrochemical performance of a high-performance electrochemical cell including a composite solid electrolyte according to one or more embodiments; and

FIG. 11 shows SEM images of lithium morphology analysis of the high-performance electrochemical cell described in FIG. 10.

### DETAILED DESCRIPTION

In order to sufficiently understand the configuration and effect of embodiments of the present disclosure, example embodiments of the present disclosure will be described in more detail with reference to the accompanying drawings, and may be easily practiced by a person skilled in the art. However, it should be noted that this is provided by way of example, and the present disclosure is not limited thereby and is only defined by the scope of the appended claims, and equivalents thereof, described in more detail herein. Rather, the example embodiments are provided only to disclose the subject matter of the present disclosure and let those skilled in the art fully know the scope of the present disclosure.

In the drawings, the thickness of layers, films, panels, regions, and/or the like, may be exaggerated for clarity and like reference numerals designate like elements throughout, and duplicative descriptions thereof may not be provided in the specification. Unless stated otherwise in the specification, if a portion of a layer, film, region, plate and/or the like is referred to as being “on” another portion, this includes not only the case in which the portion is “directly on” another portion but also the case in which there is another portion interposed therebetween.

Unless stated otherwise in the specification, singular expressions may include plural expressions. Also, unless stated otherwise, “A or B” may refer to “including A, including B, or including A and B.”

In the specification, a “combination thereof” may refer to a mixture, laminate, composite, copolymer, alloy, blend, and/or reaction product of constituents.

The terms “comprises,” comprising,” “comprise,” “including,” “includes,” “include,” “having,” “has,” and “have,” as used in this description, are intended to designate the presence of an embodied aspect, number, act, task, element, and/or a (e.g., any suitable) combination thereof. However, the use of these terms does not preclude or exclude the possibility of the presence or addition of one or more other components, features, numbers, acts, tasks, elements, and/or a (e.g., any suitable) combination thereof.

In one or more embodiments, the term “layer” as used herein includes not only a shape formed or provided on the whole surface if viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments may be described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the appended claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device may be calculated. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 20 particles at random in a scanning electron microscopic image.

The following description includes non-limiting examples of values for quantities that are a part of the present disclosure. The example values are described as example ranges for the quantities and it will be understood that any and all of the following example ranges may include any sub-range beginning and/or ending with any value thereof. An example range of “about 60% to about 80%” may also include, for example, about 60.0% to about 75%, about 68% to about 80.0%, about 68% to about 72%, about 69.5% to about 70.5%, about 70.0%, and about 70%.

### Polymer Composition

One or more embodiments of the present disclosure are directed to a polymer composition that includes a first monomer, a second monomer, an unsaturated hydrocarbon, nanoparticles, a metal salt, and a stabilizer, but the present disclosure is not limited thereto. For example, the polymer composition may include a third monomer, fourth monomer, a fifth monomer, and/or the like. The polymer composition may be a polymerizable composition that is configured for in situ polymerization. For example, the polymer composition may be activated to polymerize, or otherwise undergo polymerization. In some embodiments, the activation may include treating the polymer composition with heat, light, pressure, or a combination thereof. The polymer composition may be polymerized to provide a polymerized composition and/or an entangled polymer having a polymer network as described in more detail herein, but the present disclosure is not limited thereto.

The polymer composition, the entangled polymer, and/or the polymer network may include repeating units of the first monomer having a first moiety. The first monomer may include an alkyl acrylate functionality and/or an aryl acrylate functionality. The alkyl acrylate functionality may include an alkyl group having 1 to 20 carbon atoms. For example, the alkyl acrylate functionality may be at least one of a linear alkyl acrylate functionality containing a linear alkyl group having 1 to 12 carbon atoms, or a branched alkyl acrylate functionality containing a branched alkyl group having 3 to 12 carbon atoms. For example, the linear alkyl acrylate functionality may be selected from among (meth)acrylate, ethyl acrylate, propyl acrylate, butyl acrylate, n-hexyl acrylate, n-octyl acrylate, n-nonyl acrylate, and/or the like, but the present disclosure is not limited thereto. For example, the branched alkyl acrylate functionality may be selected from among 2-ethylhexyl acrylate, iso-nonyl acrylate, iso-octyl acrylate, and/or the like, but the present disclosure is not limited thereto.

In some embodiments, the first monomer may include ethyl acrylate.

The repeating units of the first monomer may form a main chain of the polymer composition, the entangled polymer, and/or the polymer network. In 100 parts by weight (pbw) of the polymer composition, the entangled polymer, and/or the polymer network, the first monomer may be included in an amount of about 1 pbw to about 99 pbw, about 5 pbw to about 90 pbw, about 30 pbw to about 85 pbw, or about 40 pbw to about 70 pbw.

The polymer composition, the entangled polymer, and/or the polymer network may include repeating units of the second monomer having at least one second moiety. The second monomer may include one or more suitable crosslinking monomers selected from among an alkyl diacrylate, a bicycloalkyl diacrylate, a cycloalkyl diacrylate, a tricycloalkyl diacrylate, an aryl diacrylate, and combinations thereof, but the present disclosure is not limited thereto. The alkyl diacrylate may include an alkyl group having 1 to 20 carbon atoms. The bicycloalkyl diacrylate may include a bicycloalkyl group having 1 to 20 carbon atoms. The cycloalkyl diacrylate may include a cycloalkyl group having 1 to 20 carbon atoms. The tricycloalkyl diacrylate may include a tricycloalkyl group having 1 to 20 carbon atoms. The aryl diacrylate may include an aryl group having 1 to 20 carbon atoms.

In some embodiments, the second monomer may include tricyclo [5.2.1.0 2,6] decanedimethanol diacrylate (TDDA), but the present disclosure is not limited thereto.

The repeating units of the second monomer may be in the main chain of the polymer composition, the entangled polymer, and/or the polymer network. In 100 parts by weight (pbw) of the polymer composition, the entangled polymer, and/or the polymer network, the second monomer may be included in an amount of about 0 pbw to about 50 pbw, about 1 pbw to about 40 pbw, about 3 pbw to about 45 pbw, or about 5 pbw to about 15 pbw.

In some embodiments, the polymer composition, the entangled polymer, and/or the polymer network may include repeating units of the first monomer connected to the second monomer.

The polymer composition, the entangled polymer, and/or the polymer network may include the unsaturated hydrocarbon having at least one third moiety. The unsaturated hydrocarbon may include a substituted or unsubstituted C₁ to C₁₈ alkene, or a substituted or unsubstituted C₁ to C₁₈ alkyne, and may be linear, branched and/or cyclic. The unsaturated hydrocarbon may include at least two third moieties. The third moiety may include a double bond having at least one C atom and/or a triple bond having at least one C atom. In some embodiments, the third moiety may be a cyano group, a carbonyl group, a C—C double bond, a C—C triple bond, or a C—N double bond.

The unsaturated hydrocarbon may include a substituted or unsubstituted C₁ to C₁₈ N-containing unsaturated hydrocarbon. In some embodiments, the unsaturated hydrocarbon may include at least two third moieties and may have 1 to 18 carbon atoms. For example, the unsaturated hydrocarbon may be selected from among methyl dinitrile, succinonitrile (e.g., ethyl dinitrile), propyl dinitrile, butyl dinitrile, n-hexyl dinitrile, n-octyl dinitrile, n-nonyl dinitrile, and/or the like, but the present disclosure is not limited thereto. For example, the unsaturated hydrocarbon may be succinonitrile, but the present disclosure is not limited thereto.

In 100 parts by weight (pbw) of the polymer composition, the entangled polymer, and/or the polymer network, the unsaturated hydrocarbon may be included in an amount of about 0 pbw to about 50 pbw, about 1 pbw to about 40 pbw, about 3 pbw to about 20 pbw, or about 5 pbw to about 15 pbw.

### Nanoparticles

The polymer composition, the entangled polymer, and/or the polymer network may include nanoparticles having a coating on a surface of the nanoparticles. The coating may include a trialkoxysilyl alkyl acrylate having alkoxy groups having 1 to 20 carbon atoms that may be linear, branched and/or cyclic. The trialkoxysilyl alkyl acrylate included in the coating may include an alkyl acrylate including at least one of a linear alkyl acrylate containing a linear alkyl group having 1 to 12 carbon atoms or a branched alkyl acrylate containing a branched alkyl group having 3 to 12 carbon atoms. In some embodiments, the coating includes (trimethoxysilyl)propyl (meth)acrylate (TMP), but the present disclosure is not limited thereto. The coating may include fourth moieties, as described in more detail herein.

The nanoparticles include a core and a shell on the core, e.g., the shell may be the coating on a surface of the core of the nanoparticles. The core may include at least one compound that includes at least one selected from among a metal, a nonmetal, a metalloid, and combinations thereof. In one or more embodiments, the compound in the core may include at least one selected from among silica (SiO₂), alumina, and a transition metal oxide. For example, the compound in the core may include silica (SiO₂).

The term “nanoparticle” as used herein may be defined as having either a single particle form or a secondary particle form. The single particle form refers to an individual (e.g., single) particle without a grain boundary or interface. This can include a single crystal, a polycrystalline material containing several crystals, a monolithic structure, a single unitary structure, or a non-aggregated particle. The presence of a grain boundary in the polycrystalline materials does not necessarily preclude them from being in a single particle form. Conversely, the secondary particle form includes an aggregated structure where at least two primary nanoparticles are combined, forming a spherical or oval shape. This form may have a grain boundary or interface coating layer that enhances structural stability and electric conductivity. In summary, the nanoparticle may either be a single particle form, characterized by its non-aggregated structure and small size, or a secondary particle form, characterized by the aggregation of primary nanoparticles and the presence of a grain boundary or interface coating layer.

The polymer composition, the entangled polymer, and/or the polymer network may include a nanoparticle composite that includes a secondary particle in which primary nanoparticles are aggregated, and the coating layer (shell) on a surface of the secondary particle. The coating layer may also be between the primary nanoparticles, and for example, the primary nanoparticles may be coated with the coating layer. In one or more embodiments, the secondary particles may be dispersed in the coating layer.

In one or more embodiments, the nanoparticles may have a single particle form including primary cores having the coating on a surface of the primary cores. In one or more embodiments, the nanoparticles have a secondary particle form that includes secondary particles and each secondary particle is an aggregate of at least two primary cores. The primary cores may include silica (SiO₂).

In one or more embodiments, an average particle diameter (D50) of the primary cores may be about 1 nanometer (nm) to about 500 nm, about 5 nm to about 400 nm, about 30 nm to about 380 nm, about 60 nm to about 300 nm, about 100 nm to about 140 nm, or about 110 nm to about 130 nm, but the present disclosure is not limited thereto.

In one or more embodiments, an average particle diameter (D50) of the secondary particle may be about 0.5 micrometers (μm) to about 50 μm, about 1 μm to about 25 μm, about 3 μm to about 15 μm, about 4 μm to about 10 μm, about 5 μm to about 8 μm, but the present disclosure is not limited thereto.

In one or more embodiments, the nanoparticles have a coating including (trimethoxysilyl)propyl (meth)acrylate (TMP) and a core (e.g., primary core) including silica (SiO₂). The nanoparticles may be TPM-coated SiO₂ nanoparticles and may enhance adhesion through covalent bonds between methacrylate groups of TMP and polymer chains to increase adhesion between the nanoparticles and the polymer network. This added adhesion may enhance or improve mechanical strength.

In 100 parts by weight (pbw) of the polymer composition, the entangled polymer, and/or the polymer network, the nanoparticles may be included in an amount of about 0 pbw to about 50 pbw, about 1 pbw to about 40 pbw, about 3 pbw to about 20 pbw, or about 5 pbw to about 15 pbw.

The polymer composition, the entangled polymer, and/or the polymer network may include a metal salt having at least one metal ion, and at least one counter ion including —F, —Cl, —Br, —I, —OH, —S(═O)—, —S(═O)₂—, —C(═O)—, —C(═O)O—, —OC(═O), —OC(═O)O—, —CN, —CF₃, —CF₂H, —CFH₂, —ClO, —ClO₂, —ClO₃, —ClO₄, —BF₄, —SCN, —AsF₆, —PF₆, —CF₃SO₃, or a combination thereof. For example, the metal ion may be an ion of an alkali metal, an alkaline earth metal, and/or a transition metal, and may include a plurality of metal ions. In some embodiments, the metal salt may be a lithium salt, a lithium imide salt or combinations thereof. The metal salt may be at least one selected from among a lithium imide salt, LiSCN, LiN(CN)₂, LiClO₄, LiBF₄, LiAsF₆, LiPF₆, LiCF₃SO₃, LiC(CF₃SO₂)₃, LiC(FSO₂)₃, LiSbF₆, LiPF₃(CF₂CF₃)₃, LiPF₃(CF₃)₃, and LiB(C₂O₄)₂. In some embodiments, the lithium imide salt may be at least one selected from among lithium bis(trifluoromethanesulfonyl)imide (LiN(SO₂CF₃)₂ (LiTFSI)), lithium bis(fluorosulfonyl)imide (LiN(SO₂F)₂ (LiFSI)), lithium (fluorosulfonyl) (nonafluorobutanesulfonyl)imide (LiFNSI), lithium bis(cyano)imide (LiN(CN)₂), lithium bis(pentafluoroethanesulfonyl)imide (LiN(SO₂C₂F₅)₂), lithium oligometric fluorosulfonyl imide, and combinations thereof. In some examples, the lithium imide salt comprises LiTFSI. In some examples, the lithium imide salt consists essentially of LiTFSI. In some examples, the lithium imide salt consists of LiTFSI.

The polymer composition, the entangled polymer, and/or the polymer network may include a stabilizer to enhance operational performance of an all-solid-state lithium metal battery at interfacial areas where the electrode(s) of the battery contact(s) a composite solid electrode (CSE) including the entangled polymer, as described in more detail herein. The stabilizer may be an organic compound including a carbonate, an ester, an ether, a ketone, an alcohol, or combinations thereof, each independently substituted or unsubstituted. For example, the stabilizer may be selected from among N-methyl-2-pyrrolidinone, propylene carbonate, ethylene carbonate (EC), fluoroethylene carbonate (FEC), butylene carbonate, dimethyl carbonate (DMC), diethyl carbonate (DEC), gamma-butyrolactone, 1,2-dimethoxyethane, tetrahydroxy franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, methyl propionate, ethyl propionate, and combinations thereof.

In 100 parts by weight (pbw) of the polymer composition, the entangled polymer, and/or the polymer network, the stabilizer may be included in an amount of about 0 pbw to about 50 pbw, about 1 pbw to about 40 pbw, about 3 pbw to about 20 pbw, or about 5 pbw to about 15 pbw.

The polymer composition, the entangled polymer, and/or the polymer network may include an initiator (e.g., polymerization initiator) that may include a suitable thermal initiator or photoinitiator. For example, the initiator may include azobisisobutyronitrile (AIBN), 2-hydroxy-2-methylpropiophenone (Irgacure 1173@), or combinations thereof, but the present disclosure is not limited thereto.

In one or more embodiments, each of the first moiety, the second moiety, the third moiety, and the fourth moieties may independently be a double bond having at least one C atom or a triple bond having at least one C atom. The first moiety, the second moiety, the third moiety, and the fourth moieties may each independently be a cyano group, a carbonyl group, a C—C double bond, a C—C triple bond, or a C—N double bond.

The polymer composition, the entangled polymer, and/or the polymer network may have a ratio (RM) of moles of the second monomer to moles of the first monomer of about 10⁻⁶ to about 10⁻¹, about 10⁻⁵ to about 10⁻², about 10^{-4.5} to about 10^{-2.5}, about 10⁻⁴ to about 10⁻³, or about 10^{-3.6} to about 10^{-3.4}, but the present disclosure is not limited thereto.

The polymer composition, the entangled polymer, and/or the polymer network may have a ratio (RV) of a volume of the first monomer to a volume of the nanoparticles of about 5:0 to about 1:3 or about 1:0 to about 1:1. For example, RV may be about 1:0.10, about 1:0.20, about 1:0.30, or about 1:0.40, but the present disclosure is not limited thereto.

### Entangled Polymer

One or more embodiments of the present disclosure are directed to an entangled polymer that may be provided from the polymer composition as described herein. The entangled polymer may be a polymerized composition produced by in situ polymerization of the polymer composition having a polymer network that includes crosslinking between suitable combinations of the first, second, third moiety, and/or fourth moieties (e.g., functional groups) as described herein, but the present disclosure is not limited thereto. The polymer network may include a plurality of chemical bonds between any selected from among the first moiety, the second moiety, the third moiety, and the fourth moieties. In one or more embodiments, the chemical bonds may be selected from among covalent bonds, ionic bonds, intermolecular attractions, and combinations thereof.

The polymer network includes covalent bonds between the nanoparticles and the polymerized composition. During polymerization, interactions between nanoparticles may cause aggregation into secondary particles that have increased or enhanced adhesion with the polymerized composition. For example, the aggregated secondary particles may facilitate crosslinking within the polymer network.

The crosslinking of the polymerized composition, the polymer network and/or the entangled polymer creates crosslinked polymer chains having substantial elasticity that facilitates the distribution of stress throughout the entangled polymer. For example, the stress distribution may reduce or prevent mechanical failure, e.g., during substantial and repeated changes in electrode volume.

The entangled polymer includes ion transport pathways that facilitate movement of ions (e.g., Li ions) through the composite solid electrolyte of the present disclosure. The ability of the ion transport pathways facilitate passage of ions is enhanced by the high ionic conductivity of the polymerized composition, as described in more detail elsewhere herein.

In one or more embodiments, the entangled polymer includes an ionic complex that includes the unsaturated hydrocarbon and the metal salt. For example, the ionic complex may be an imide salt-ionic complex that facilitates the passage of ions and the formation of the ion transport pathways. In some embodiments, the imide salt-ionic complex includes polar π bonds, such as C—N double bonds and/or C—N triple bonds.

In one or more embodiments, the entangled polymer may have a rubbery plateau modulus. The rubbery plateau modulus may indicate that the polymer chains of the entangled polymer have a range of lengths that provides substantial (e.g., dominant) entanglement throughout the entangled polymer. Not wishing to be limited by theory, rubbery plateau modulus may indicate that the entangled polymer has a relatively constant storage modulus over a certain temperature range, indicating a stable rubbery behavior before the material begins to flow like a liquid. The rubbery plateau modulus may be directly related to amount of chain entanglement and/or crosslink density. For example, above the glass transition temperature (Tg) transition into a rubbery state and long-range elasticity may occur. this state, the polymer chains can move past each other, but their movement is restricted by entanglement or crosslinks. The rubbery plateau signifies the region of the G′ curve where the polymer behaves as a rubber, exhibiting elasticity due to the entanglement or crosslinking of the polymer chains.

In one or more embodiments, the entangled polymer may have an elastic modulus of about 10 megapascal (MPa) to about 10,000 MPa, about 50 MPa to about 3,000 MPa, about 100 MPa to about 1,000 MPa, about 200 MPa to about 500 MPa, or about 280 MPa to about 420 MPa, but the present disclosure is not limited thereto.

In one or more embodiments, a stretchability of the entangled polymer may be about 200% to about 10,000%, about 500% to about 3,000%, about 700% to about 1,500%, or about 800% to about 1,200%, but the present disclosure is not limited thereto.

In one or more embodiments, a weight average molecular weight of the entangled polymer and/or the polymerized composition may be about 1,000 g/mol to about 100,000 g/mol. In one or more embodiments, a number average molecular weight of the entangled polymer and/or the polymerized composition may be about 1,000 g/mol to about 100,000 g/mol.

### Composite Solid Electrolyte

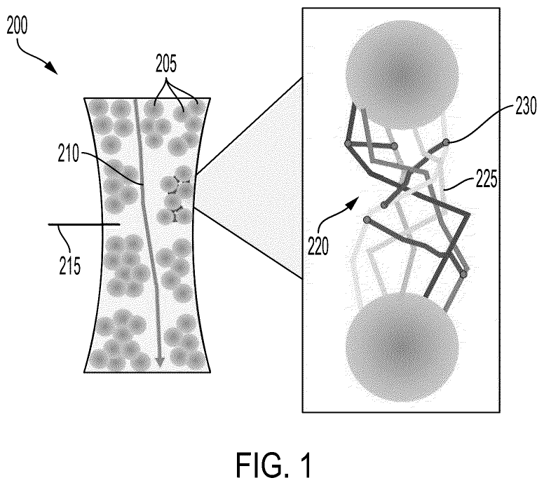

One or more embodiments of the present disclosure are directed to a composite solid electrolyte. The composite solid electrolyte may include the entangled polymer of the present disclosure. FIG. 1 illustrates a schematic of a composite solid electrolyte 200 including nanoparticles 205, an ion transport channel 210, and a polymerized composition 215. FIG. 1 shows only one ion transport channel 210, but the present disclosure is not limited thereto, e.g., the composite solid electrolyte 200 may include multiple ion transport channels 210. The expanded view of FIG. 1 shows an entangled polymer 220 having polymer chains 225 with crosslinking 230. The expanded view of FIG. 1 shows a few crosslinks 230, but the present disclosure is not limited thereto, e.g., the composite solid electrolyte 200 may include extensive crosslinking 230.

The polymerized composition, the polymer network and/or the entangled polymer of the composite solid electrolyte 200 may include the crosslinking 230. The crosslinking 230 may facilitate dissipation of mechanical stress induced by changes in electrode volume, enhance or improve interfacial stability at interfaces of the composite solid electrolyte 200 and electrodes, enhance or improve the mechanical rigidity and fatigue-resistance of the composite solid electrolyte 200. In one or more embodiments, the rubbery plateau modulus of the entangled polymer may enhance or improve the elasticity and structural integrity of the composite solid electrolyte 200, e.g., by accommodating changes in electrode volume.

In one or more embodiments, the composite solid electrolyte may have an ionic conductivity of about 0.1 millisiemens per centimeter (mS/cm) to about 50 mS/cm, about 1 mS/cm to about 20 mS/cm, about 2 mS/cm to about 10 mS/cm, about 3 mS/cm to about 4 mS/cm, or about 3.2 mS/cm to about 3.8 mS/cm, but the present disclosure is not limited thereto.

One or more embodiments of the present disclosure are directed to an all-solid-state lithium metal battery including a cathode, an anode, and the composite solid electrolyte of the present disclosure.

### Methods

One or more embodiments of the present disclosure are directed to a method of preparing a polymerizable composition. The polymerizable composition may be used to prepare a composite solid electrolyte of the present disclosure. The method includes providing a polymer composition that includes a first monomer having a first moiety; a second monomer having at least one second moiety; an unsaturated hydrocarbon having at least one third moiety; nanoparticles including a coating that has fourth moieties and the coating being on a surface of the nanoparticles; a metal salt; a stabilizer; and a thermal initiator. The method includes mixing the composition to provide a polymerizable composition.

The method may include heat treating the polymerizable composition to provide an entangled polymer. The entangled polymer may have a plurality of chemical bonds between any selected from among the first moiety, the second moiety, the third moiety, and the fourth moieties. The entangled polymer may have ion transport pathways.

The method may be a method of preparing an entangled polymer for a composite solid electrolyte for an all-solid-state lithium metal battery.

### Features of the Present Disclosure

The development of a fatigue-resistant composite solid electrolyte (CSE) having both high elasticity and rigidity represents a significant advancement in energy storage technology, for example, for ASSLMBs. Embodiments of the present disclosure have broad implications for improving the safety, performance, and sustainability of high-capacity ESSs, which are crucial in the transition to EVs, renewable energy systems, and advanced electronics.

The unique combination of high mechanical strength and elasticity in this CSE addresses one of the core challenges of ASSLMBs: the prevention or reduction of Li dendrite growth. By providing a solid electrolyte that can resist dendrite or reduce formation while accommodating the volume changes of Li metal anodes during cycling, embodiments of the present disclosure significantly reduce the risks of short circuits, thermal runaway, and battery failure. This makes ASSLMBs safer and more reliable, addressing critical safety concerns in consumer electronics and automotive applications.

Embodiments of the present disclosure exhibit improved ion conductivity and a stable interface between the CSE and a Li metal anode to support high energy density in a compact form factor, ideal for EVs and portable devices. By facilitating efficient Li-ion transport and maintaining structural integrity over extended cycles, the CSE allows for smaller, lighter batteries having prolonged lifespans and greater driving ranges in EVs. This translates into substantial improvements in vehicle efficiency, making it feasible to achieve lighter, longer-lasting battery packs that meet the demanding energy and power requirements of EVs, which is beneficial for enhancing the driving range and reducing the frequency of recharging.

The in-situ polymerizable nature of preparing the CSE enables a scalable, energy-efficient manufacturing process. The use of commercially available materials, combined with simple polymerization techniques, reduces the need for complex fabrication equipment and extensive processing times. This streamlined approach lowers production costs and simplifies the integration of this electrolyte into existing battery manufacturing lines, accelerating the path to commercialization. Furthermore, the alternative option for photoinitiated polymerization opens avenues for rapid, low-energy fabrication, offering flexibility in manufacturing while supporting the development of cost-effective, high-performance ASSLMBs.

Embodiments of the present disclosure provide for the structured organization of inorganic particles and the entanglement of polymer networks lay a strong foundation for advancements across a wide range of polymer, gel, and ceramic-based composite materials. By demonstrating how highly structured inorganic particles and entangled polymers can enhance mechanical strength, ionic conductivity, and structural stability, the subject matter of the present disclosure can be applied to develop innovative materials having tailored properties.

Hereinafter, embodiments of the present disclosure will be described in more detail through examples of the preparation and performance of the composite solid electrolytes. However, the present disclosure is not limited to the following examples.

### EXAMPLES

### Preparation of Composite Solid Electrolytes

### Example 1.1

A polymer composition was prepared by combining ethylene acrylate (EA), azobisisobutyronitrile (AIBN) as a thermal initiator, lithium bis(trifluoromethanesulfonyl)imide (LiTFSI), succinonitrile (SN), fluoroethyl carbonate (FEC), and tricyclo[5.2.1.02,6]decanedimethanol diacrylate (TDDA) as a crosslinker. A ratio (RM) of moles of TDDA to moles of EA was about 10^{-4.5}.

The polymerization composition was mixed thoroughly to provide a homogeneous polymer composition. In an argon-filled glove box having O₂ and H₂O concentrations each less than 0.1 parts per million (ppm), the homogeneous polymer composition was applied to a glass fiber and heated to about 65° C. to initiate in-situ polymerization for about 12 hours to provide a composite solid electrolyte.

### Examples 1.2 to 1.5

Examples 1.2, 1.3, 1.4 and 1.5 are composite solid electrolytes prepared in substantially the same method as Example 1.1 except that the ratio (RM) of moles of TDDA to moles of EA, respectively, was about 10⁻⁴, 10^{31 3.5}, 10⁻³, and 10^{-2.5}.

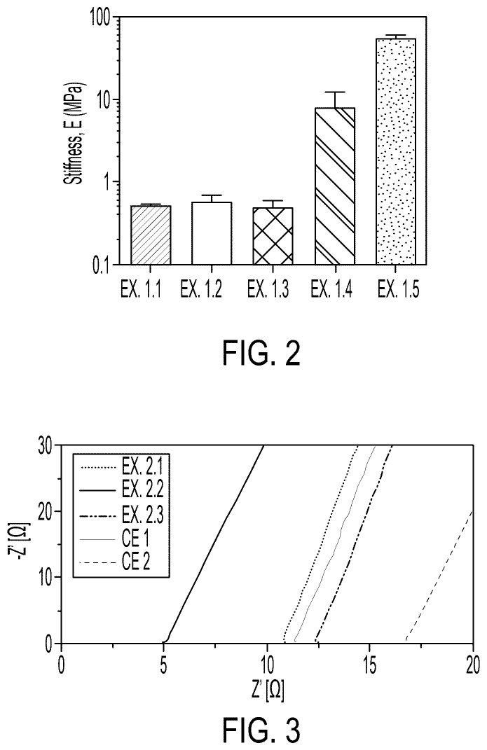

FIG. 2 shows the results of stiffness measurements with respect to the ratio (RM) for the composite solid electrolytes prepared in Examples 1.1, 1.2, 1.3, 1.4, to 1.5 abbreviated as “EX. 1.1, EX. 1.2, EX. 1.3, EX. 1.4 and EX. 1.5”. The composite solid electrolyte prepared in Example 1.3 (EX. 1.3) exhibited a stable plateau modulus region characteristic of a rubbery state, as shown in FIG. 2. The rubbery plateau modulus indicates that the composite solid electrolyte prepared in Example 1.3 (EX. 1.3) has polymer chain lengths sufficient to achieve substantial entanglement.

### Examples 2.1 to 2.3

Example 2.1 is a composite solid electrolyte that was prepared in substantially the same method as Example 1.3 except that the polymer composition further included SiO₂ nanoparticles having an average particle diameter (D50) of about 120 nanometers (nm) and coated with (trimethoxysilyl)propyl (meth)acrylate (TMP). The ratio (RV) of the volume of EA to the volume of nanoparticles was 1 to 0.10.

Example 2.2 is a composite solid electrolyte that was prepared in substantially the same method as Example 2.1 except that the ratio of the volume of EA to the volume of nanoparticles was 1 to 0.20.

Example 2.3 is a composite solid electrolyte that was prepared in substantially the same method as Example 2.1 except that the ratio of the volume of EA to the volume of nanoparticles was 1 to 0.30.

### Comparative Examples 1 and 2

Comparative Example 1 (CE 1) was produced in substantially the same method as Example 2.2 except that trimethylsilyl (TMS)-coated SiO₂ nanoparticles were used in place of the TPM-coated SiO₂ nanoparticles.

Comparative Example 2 (CE 2) was produced in substantially the same method as Example 2.2 except that the TPM-coated SiO₂ nanoparticles were not included.

### Evaluation of Composite Solid Electrolytes

### Evaluation of Ionic Conductivity

Table 1 and FIG. 3 show the results of ionic conductivity measurements at room temperature of the composite solid electrolytes prepared in Examples 2.1 to 2.3 abbreviated as “EX. 2.1, EX. 2.2, and EX. 2.3,” and Comparative Examples 1 and 2 abbreviated as “CE 1 and CE 2”. The composite solid electrolyte prepared in Example 2.2 (EX. 2.2) exhibited an ionic conductivity of about 3.45 millisiemens per centimeter (mS/cm), as shown in Table 1 and FIG. 3.

TABLE 1

| | SiO₂ Coating | Ionic conductivity | Elastic Modulus |
|---|---|---|---|
| | (RV) | (mS/cm) | (MPa) |
| EX. 2.1 | TPM | 1.56 | 50 |
| | 1:0.10 | | |
| EX. 2.2 | TPM | 3.45 | 400 |
| | 1:0.20 | | |
| EX. 2.3 | TPM | 1.37 | 470 |
| | 1:0.30 | | |
| CE 1 | TMS | 1.49 | Not measured |
| | 1:0.20 | | |
| CE 2 | None | 1.01 | 17 |

The results in Table 1 and FIG. 3 suggest that a ratio (RV) of 1:0.20 provides substantial SiO₂ dispersion to create suitable or excellent ion transport pathways (e.g., Li ion-conducting pathways) that may reduce or prevent Li ion-polymer interactions. A ratio (RV) greater than 1:0.20 may cause excessive aggregation of the nanoparticles that reduces the free volume of the composite solid electrolyte and reduces Li ion transport and ionic conductivity.

### Evaluation of Mechanical Rigidity

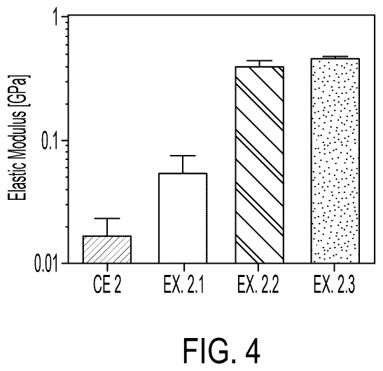

Table 1 and FIG. 4 show the results of nanoindentation of elastic modulus measurements that assessed the mechanical rigidity of the composite solid electrolytes prepared in Examples 2.1 to 2.3 (EX. 2.1, EX. 2.2, EX. 2.3) and Comparative Example 2 (CE 2). The composite solid electrolyte prepared in Example 2.2 exhibited an elastic modulus of approximately 400 megapascals (MPa), which suggests that a ratio (RV) of 1:0.20 provides mechanical rigidity sufficient to suppress Li dendrite growth. The double bond moieties in the (meth)acrylate groups of the TMP coating provide additional crosslinking to enhance the mechanical strength.

### Evaluation of Morphology, Stretchability and Resistance

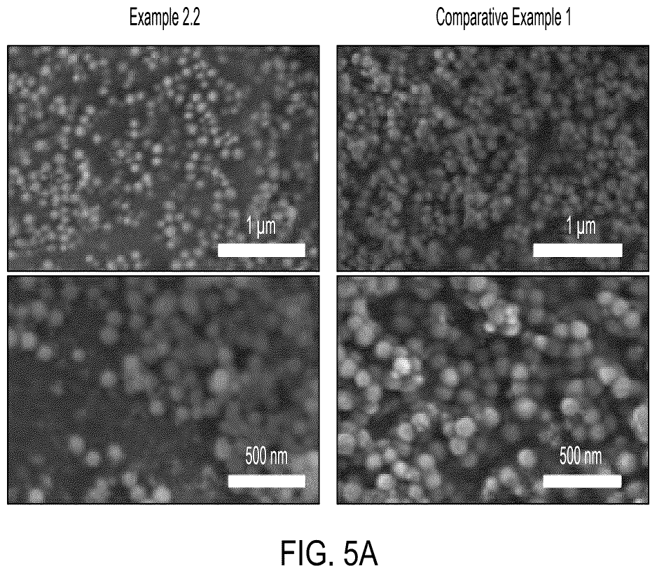

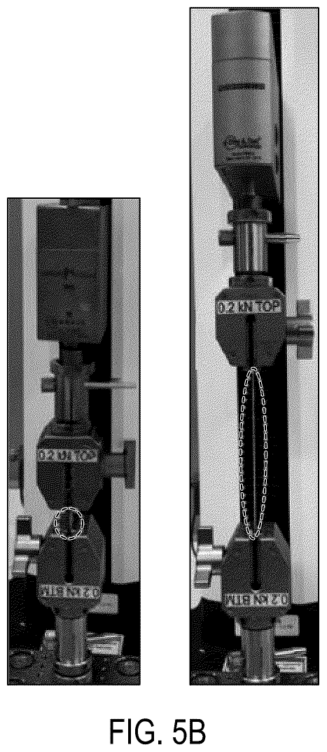

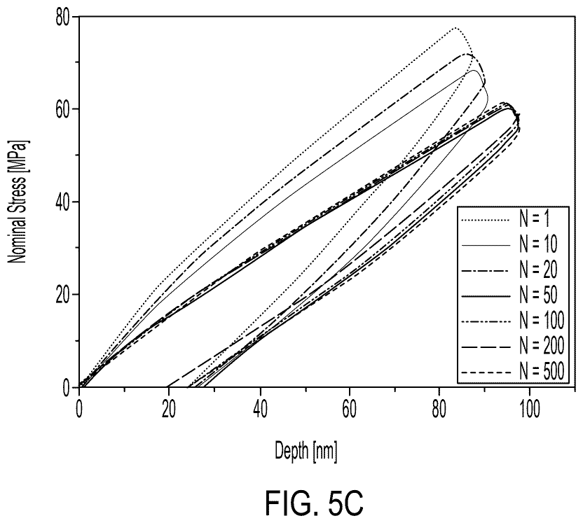

FIG. 5A shows scanning electron microscopy (SEM) images of the composite solid electrolytes prepared in Example 2.2 and Comparative Example 1. The SEM image of Example 2.2 displays aggregated secondary particles (e.g., clusters) that may be formed by covalent bonding of the (meth)acrylate groups of the TMP coating. The SEM image of Comparative Example 1 displays non-aggregated, uniformly dispersed TMS-coated SiO₂ nanoparticles that have weak adhesion due to an absence of functional groups to form covalent bonds.

FIG. 5B is a set of images showing the results of stretchability analysis as a dotted-line circle and a dotted-line oval of the composite solid electrolyte prepared in Example 2.2 that had a stretchability of about 1,000% and exhibited remarkable mechanical durability.

FIG. 5C shows the results of repetitive indentation resistance measurements of the composite solid electrolyte prepared in Example 2.2 over 500 cycles using a 200 nanometer (nm) tip and reaching an approximate depth of 100 nm. The loading-unloading curve in FIG. 5C shows a decrease in hysteresis after 50 cycles and stabilized into a consistent pattern, which indicates suitable or excellent resistance to fatigue.

### Evaluation of Electrochemical Performance

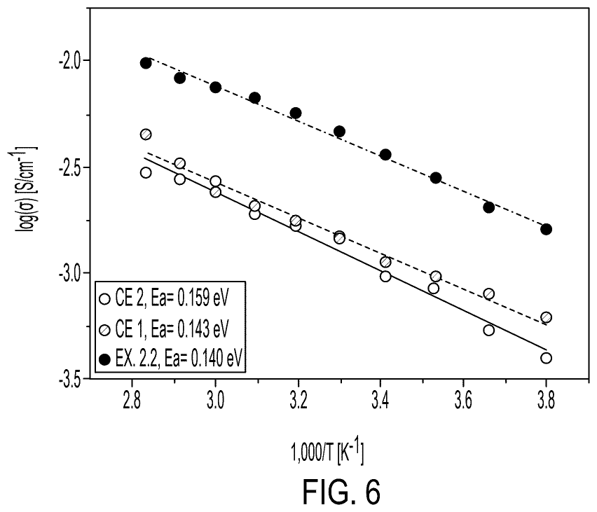

FIG. 6 shows the results of electrochemical performance measurements at room temperature of the composite solid electrolytes prepared in Example 2.2 (EX. 2.2) and Comparative Examples 1 and 2 (CE 1 and CE 2). The ionic conductivity of Example 2.2 and Comparative Examples 1 and 2, respectively, were 0.00356 S/cm, 0.00113 S/cm, and 0.000978 S/cm. The high conductivity (0.00356 S/cm) of the composite solid electrolyte of Example 2.2 (EX. 2.2) may be attributed to the aggregated secondary particles which may reduce or prevent interactions between Li ions and the polymer matrix and enhance or improve ion mobility.

The activation energy for ion conduction calculated from Arrhenius plots of Example 2.2 (EX. 2.2) and Comparative Examples 1 and 2 (CE 1 and CE 2), respectively, were 0.140 eV, 0.143 eV, and 0.159 eV, as shown in FIG. 6. The low activation energy (0.140 eV) of the composite solid electrolyte of Example 2.2 (EX. 2.2) may indicate a lower energy barrier for ion migration.

### Evaluation of Electrochemical Stability

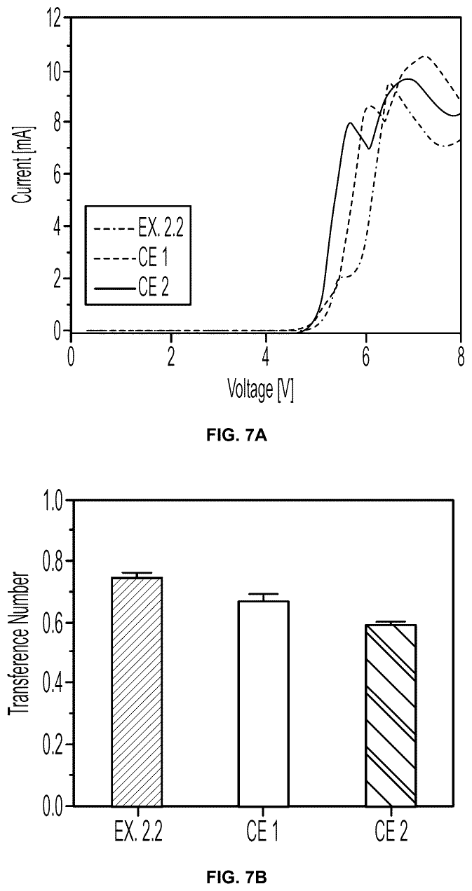

FIGS. 7A-7B show the results of evaluation of electrochemical stability of the composite solid electrolytes prepared in Example 2.2 (EX. 2.2) and Comparative Examples 1 and 2 (CE 1 and CE 2) using linear sweep voltammetry (LSV). The electrochemical stability window for the composite solid electrolyte of Example 2.2 (EX. 2.2) extended up to 5.0 V vs. Li/Li⁺, as shown in FIG. 7A, which indicates suitable compatibility with high-voltage cathodes. The Li-ion transference number for the composite solid electrolytes prepared in Example 2.2 (EX. 2.2) and Comparative Examples 1 and 2 (CE 1 and CE 2), respectively, were 0.76, 0.68. and 0.60, as shown in FIG. 7A.

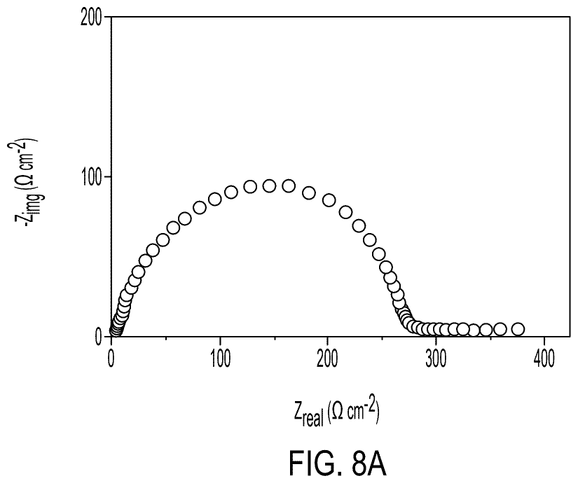

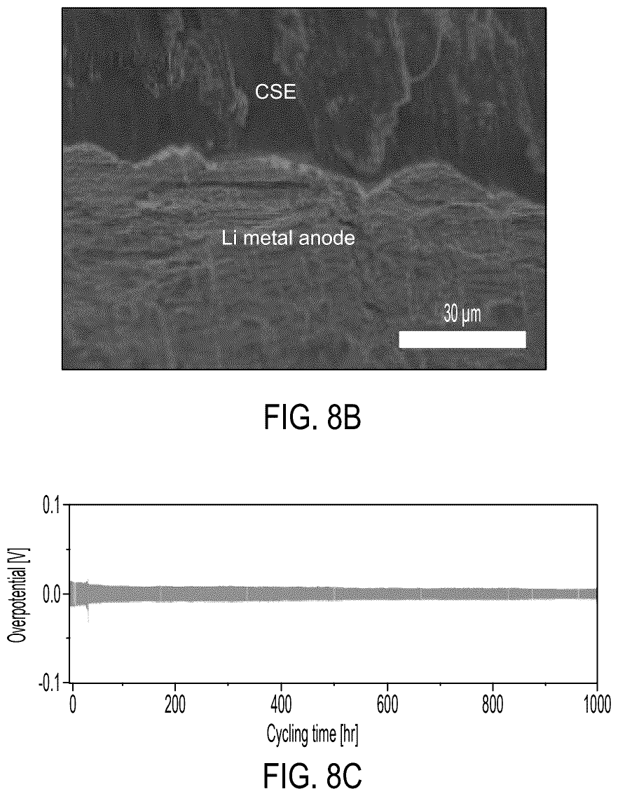

FIG. 8A shows that the charge transfer resistance of a Li∥Li symmetric cell including the composite solid electrolyte (CSE) prepared in Example 2.2 (EX. 2.2) was a suitably low value of about 270 ohm-square centimeter (Ω·cm²), as measured by electrochemical impedance spectroscopy. FIG. 8B is an SEM image of the symmetric cell showing conformal solidification of the CSE on the Li surface that provides substantial interfacial contact between the CSE (upper region of FIG. 8B) and the Li metal anode (lower region of FIG. 8B). FIG. 8C shows the results of plating and stripping tests of the symmetric cell at 0.3 milliampere per square centimeter (mA/cm²) and demonstrates a stable voltage plateau at 8 millivolts (mV) over 1,000 cycles with minimal overpotential increase. The outstanding cycling stability of the symmetric cell may be attributed to the mechanical strength, Li dendrite formation suppression, Li-ion conductivity, and enhanced interfacial stability of the composite solid electrolyte of the present disclosure.

### Evaluation of Electrochemical Cells Including the Composite Solid Electrolytes

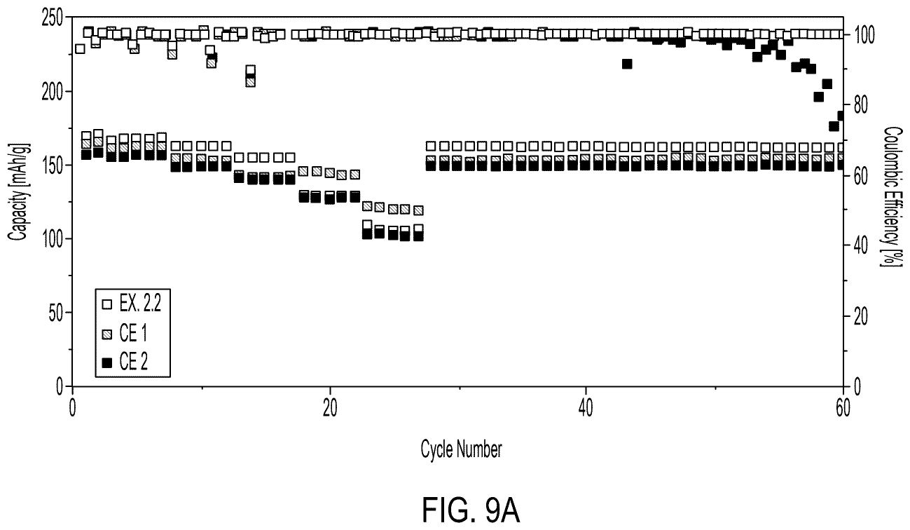

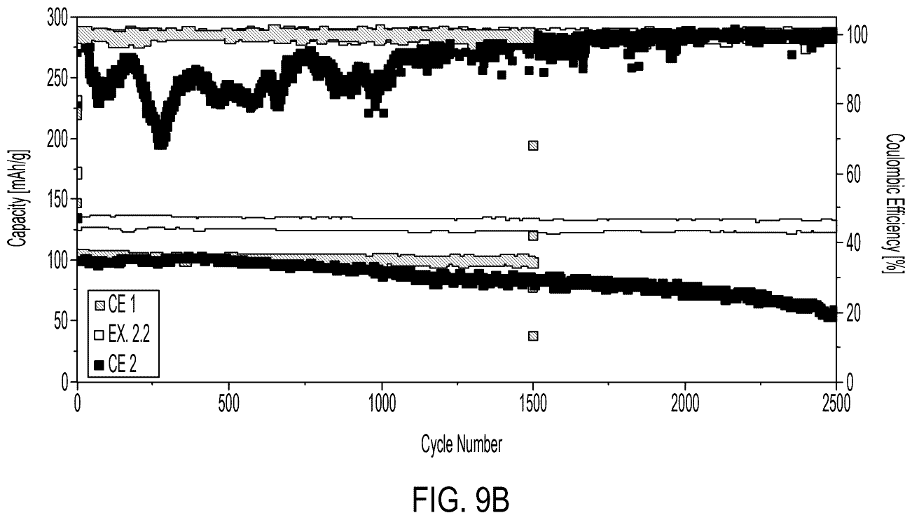

FIGS. 9A-9B show the results of the evaluation of electrochemical performance of electrochemical cells prepared from the composite solid electrolytes prepared in Example 2.2 (EX. 2.2) and Comparative Examples 1 and 2 (CE 1 and CE 2). The electrochemical cells included a lithium metal anode and a lithium iron phosphate (LFP) cathode and were tested over a voltage range of 2.8 to 3.9 V.

FIG. 9A shows that the discharge capacity at a rate of 0.2C was about 169 mAh/g for the electrochemical cells prepared from Example 2.2 (EX. 2.2) and Comparative Example 1 (CE 1), which approached the theoretical capacity of LFP. The discharge capacity at a rate of 0.2C was 160 mAh/g for Comparative Example 2 (CE 2). These results indicate that a composite solid electrolyte including the nanoparticles of the present disclosure may enhance the electrochemical performance of an ASSLMB.

FIG. 9A shows that the discharge capacities of Example 2.2 (EX. 2.2) at rates of 0.5C, 1C, 2C, and 5C, respectively, were 162 mAh/g, 155 mAh/g, 144 mAh/g, and 122 mAh/g and demonstrates the excellent rate capability of a composite solid electrolyte of the present disclosure. FIG. 9A shows that the discharge capacities of Comparative Examples 1 and 2 (CE 1 and CE 2) at rates of 0.5C, 1C, 2C, and 5C were decreased when compared to Example 2.2 (EX. 2.2).

FIG. 9B shows the results of cyclic testing at 3C, wherein the discharge capacities of Example 2.2 (EX. 2.2) and Comparative Examples 1 and 2 (CE 1 and CE 2), respectively, were 131 mAh/g, 105 mAh/g, and 99 mAh/g. The average coulombic efficiency of Example 2.2 (EX. 2.2) was maintained at 99.94% over 2,500 cycles while average coulombic efficiencies of Comparative Examples 1 and 2 (CE 1 and CE 2) dropped significantly after about 1,500 and 1,000 cycles, respectively.

### Example 3

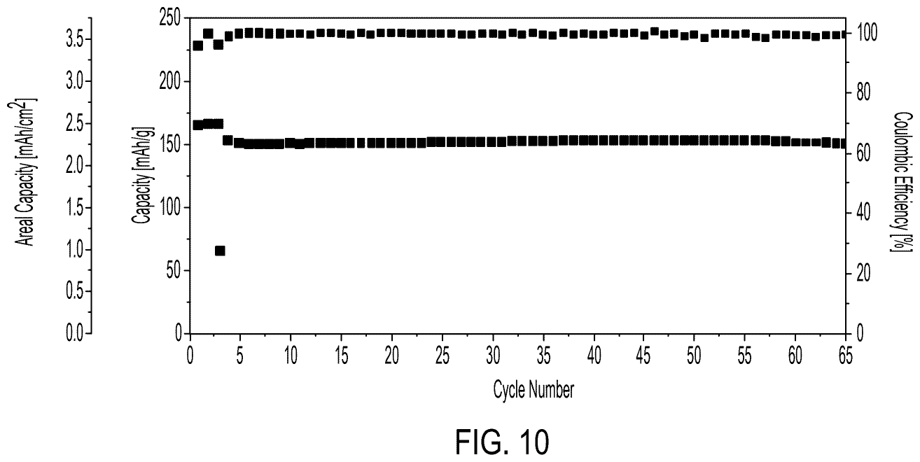

FIG. 10 shows the results of electrochemical performance of Example 3, which was a high-performance electrochemical cell including the composite solid electrolyte of Example 2.2 (EX. 2.2), a thin foil lithium metal anode (35 μm, about 7 mAh/cm²), and a high areal capacity LFP cathode (15.38 mg/cm², about 2.6 mAh/cm²) that was evaluated at a negative to positive capacity (N/P) ratio of 2.7. At a current density of 1 mA/cm², the cell of Example 3 sustained a stable capacity of 160 mAh/g over 200 cycles, with 85% capacity retention and a high coulombic efficiency of 99.3%.

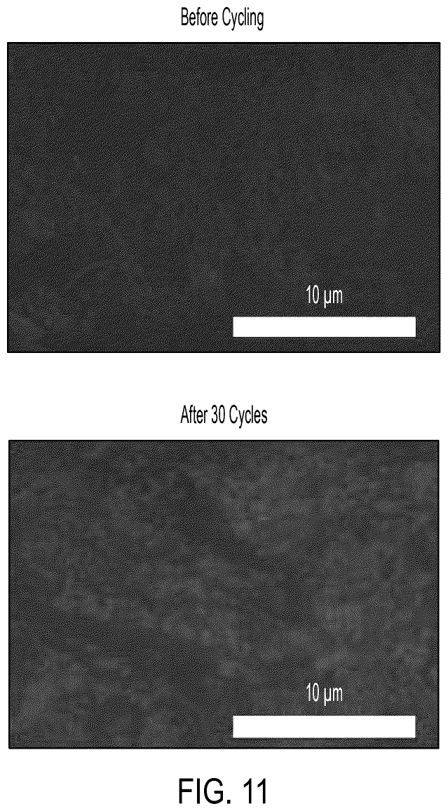

FIG. 11 shows images of lithium morphology analysis of the cell of Example 3 before and after cycling that confirmed uniform Li deposition and demonstrate that the composite solid electrolyte of the present disclosure may prevent or suppress Li dendrite formation and enable stable, long-term operation of an all-solid-state lithium (Li) metal battery (ASSLMB).

The preceding results indicate that the composite solid electrolytes of the present disclosure are elastic, rigid and fatigue-resistant and thus well-suited for use in an ASSLMB. The suitability of composite solid electrolytes is demonstrated by their enhanced ionic conductivity and mechanical rigidity, low activation energy, broad electrochemical stability window, and enhanced electrochemical performance, as exhibited herein.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

Hereinafter, the annotations used in FIG. 1 are listed.

Reference Numerals

| | |
|---|---|
| 200: composite solid electrolyte | 205: nanoparticles |
| 210: ion transport channel | 215: polymerized composition |
| 220: entangled polymer | 225: polymer chains |
| 230: crosslinking | |

What is claimed is:

1. A polymer composition comprising:
repeating units comprising a first monomer having a first moiety and a second monomer having at least one second moiety;
an unsaturated hydrocarbon having at least one third moiety;
nanoparticles having a coating on a surface thereof, the coating having fourth moieties;
a metal salt; and
a stabilizer,
wherein the polymer composition is a polymerizable composition.

2. The polymer composition as claimed in claim 1, wherein:
the first monomer comprises a (meth)acrylate,
the second monomer comprises a diacrylate,
the unsaturated hydrocarbon comprises a substituted or unsubstituted C₁ to C₁₈ N-containing unsaturated hydrocarbon and the third moiety comprises a cyano group,
the metal salt comprises at least one metal ion and at least one counter ion comprising —F, —Cl, —Br, —I, —OH, —S(═O)—, —S(═O)₂—, —C(═O)—, —C(═O)O—, —OC(═O), —OC(═O)O—, —CF₃, —CF₂H, —CFH₂, —CCl₃, or a combination thereof, and
the stabilizer comprises a carbonate, an ester, an ether, a ketone, an alcohol, or combinations thereof, each independently substituted or unsubstituted.

3. The polymer composition as claimed in claim 1, wherein each of the first moiety, the second moiety, the third moiety, and the fourth moieties, independently comprise a double bond having at least one C atom or a triple bond having at least one C atom.

4. The polymer composition as claimed in claim 1, wherein the nanoparticles have a core comprising a compound comprising a metal, a nonmetal, a metalloid, or combinations thereof.

5. The polymer composition as claimed in claim 1, wherein the nanoparticles have a core comprising SiO₂.

6. The polymer composition as claimed in claim 1, wherein the coating comprises a trialkoxysilyl alkyl acrylate.

7. The polymer composition as claimed in claim 1, wherein the nanoparticles comprise:
a single particle form comprising primary cores having the coating on a surface thereof, or
a secondary particle form comprising secondary particles, each secondary particle comprising an aggregate of at least two primary cores.

8. The polymer composition as claimed in claim 1, wherein
an average particle diameter of the primary cores is about 100 nanometers (nm) to about 140 nm, and
an average particle diameter of the secondary particles is about 0.5 micrometers (μm) to about 50 μm.

9. The polymer composition as claimed in claim 1, wherein a ratio (RM) of moles of the second monomer to moles of the first monomer is about 10⁻⁵ to about 10⁻².

10. The polymer composition as claimed in claim 1, wherein a ratio (RV) of a volume of the first monomer to a volume of the nanoparticles is about 1:0 to about 1:1.

11. An entangled polymer comprising:
a polymerized composition comprising the polymer composition as claimed in claim 1;
a plurality of chemical bonds between any selected from among the first moiety, the second moiety, the third moiety, and the fourth moieties; and
ion transport pathways,
wherein the chemical bonds comprise covalent bonds, ionic bonds, intermolecular attractions, and combinations thereof.

12. The entangled polymer as claimed in claim 11, the entangled polymer further comprising an ionic complex comprising the unsaturated hydrocarbon and the metal salt.

13. The entangled polymer as claimed in claim 11, wherein the entangled polymer has a rubbery plateau modulus.

14. The entangled polymer as claimed in claim 11, wherein the entangled polymer has an elastic modulus of about 100 megapascal (MPa) to about 1,000 MPa.

15. The entangled polymer as claimed in claim 11, wherein a stretchability of the entangled polymer is about 500% to about 3,000%.

16. A composite solid electrolyte comprising the entangled polymer as claimed in claim 11.

17. The composite solid electrolyte as claimed in claim 16, the composite solid electrolyte having an ionic conductivity of about 3 millisiemens per centimeter (mS/cm) to about 4 mS/cm.

18. An all-solid-state lithium metal battery comprising:
a cathode;
an anode;
and the composite solid electrolyte as claimed in claim 16.

19. A method comprising:
providing a polymer composition comprising:
a first monomer having a first moiety;
a second monomer having at least one second moiety;
an unsaturated hydrocarbon having at least one third moiety;
nanoparticles having a coating on a surface thereof, the coating having fourth moieties;
a metal salt;
a stabilizer; and
a thermal initiator, and
mixing the composition to provide a polymerizable composition,
wherein the method is a method of preparing a polymerizable composition for a composite solid electrolyte.

20. The method as claimed in claim 19, further comprising:
heat treating the polymerizable composition to provide an entangled polymer,
the entangled polymer having
a plurality of chemical bonds between any selected from among the first moiety, the second moiety, the third moiety, and the fourth moieties, and
ion transport pathways,
wherein the method is a method of preparing an entangled polymer for a composite solid electrolyte for an all-solid-state lithium metal battery.
